(19) United States
(12) Patent Application Publication
(10) Pub. No.: US 2017/0250388 A1
(43) Pub. Date: Aug. 31, 2017

(54) PRISMATIC SECONDARY BATTERY

(71) Applicant: HITACHI AUTOMOTIVE SYSTEMS, LTD., Ibaraki (JP)

(72) Inventors: Akira UNNO, Ibaraki (JP); Hayato KOGUCHI, Ibaraki (JP); Hiroaki EGAWA, Ibaraki (JP)

(73) Assignee: HITACHI AUTOMOTIVE SYSTEMS, LTD., Ibaraki (JP)

(21) Appl. No.: 15/504,196

(22) PCT Filed: May 21, 2015
(86) PCT No.: PCT/JP2015/064597

§ 371 Date: Feb. 15, 2017

(30) Foreign Application Priority Data
Sep. 3, 2014 (JP) 2014-179603

(51) Int. Cl. H01M 2/12; H01M 2/02; H01M 10/04

(52) U.S. Cl. CPC H01M 2/1264; H01M 10/0431; H01M 2/0267; H01M 2/0277

(57) ABSTRACT

An object of the invention is to obtain a rectangular secondary battery in which an outer surface of the battery has an insulating property and watertightness, and a short-circuit due to dew condensation water or the like does not occur between battery containers of adjacent batteries or between a battery container and a housing of a battery pack. A rectangular secondary battery (90) of the present invention for solving the foregoing problems is a rectangular secondary battery in which six faces of a battery container are covered with one sheet of insulating film (50). The rectangular secondary battery (90) is characterized in that, ends of the insulating film are overlapped with each other, and the insulating film continuously covers mutually adjacent faces having each of ridges between the faces of the battery container.

### TECHNICAL FIELD

The present invention relates to a rectangular secondary battery, more particularly, a rectangular secondary battery having an insulating film on an outer face of a battery container.

### BACKGROUND ART

In a rectangular secondary battery such as a lithium-ion secondary battery, an electrode group as a power generating element is housed, and an electrolyte solution is injected in a battery can that is formed of metal such as aluminum. The battery can has a peripheral side surface, a bottom surface, and an open upper surface. The peripheral side surface is typically formed in a cross-sectional rectangular shape that has a pair of wide-width surfaces, and a pair of narrow-width surfaces coupled to the wide-width surfaces. The battery can houses an electrode group, and a battery lid provided with external terminals of positive and negative electrodes seals the upper opening part of the battery can into which the electrolyte solution has been injected. The battery lid is insulated from the positive and negative electrode external terminals. The battery can and the battery lid have a different electrical potential than the positive or negative electrodes, and are neutral without polarity.

Since the battery can and the battery lid are made of metal, if a metal surface is an exposed state, the battery can may come into contact with external terminals of another secondary battery, a circuit of an upper-level product, or the like, and short-circuit may occur with higher possibility. Against this, there is known a means that prevents a short-circuit by bonding an insulating outer sheet (or film) on an outer surface of the battery can (e.g., see PTL 1).

If the external terminals protrude, however, in order to improve bonding property, the shape of the outer sheet (or film) needs to be such that the outer surface around the external terminals of the battery can is slightly exposed.

### CITATION LIST

### Patent Literature

PTL 1: JP 10-97850 A

### SUMMARY OF INVENTION

### Technical Problem

In the PTL 1, while the battery can is provided with an insulating property by bonding an insulating outer sheet to the outer surface of the battery can excluding the periphery of the external terminals, the battery can is slightly exposed at a butted part of outer sheet ends since the outer sheet is not overlapped. Although this may be sufficient when considering insulation of a battery unit, it may not always be sufficient for insulation of a battery pack of a plurality of secondary batteries combined in series or parallel because it is also necessary to prevent a short-circuit due to dew condensation water or the like between the battery can and a battery can of an adjacent battery, or between the battery can and a housing of the battery pack. Accordingly, the present invention has been devised in consideration of the foregoing problems, and it is an object of the invention to provide a battery in which an outer surface of the battery has an insulating property and watertightness, and a short-circuit due to dew condensation water or the like does not occur between battery cans of adjacent batteries or between a battery can and a housing of a battery pack.

### Solution to Problem

A rectangular secondary battery of the present invention for solving the foregoing problems is a rectangular secondary battery in which six faces of a battery container are covered with one sheet of insulating film. The rectangular secondary battery is characterized in that ends of the insulating film are overlapped with each other, and the insulating film continuously covers mutually adjacent faces having each of ridges therebetween of the battery container.

### Advantageous Effects of Invention

According to the present invention, the insulating property and watertightness of the outer surface of the battery can be maintained. Therefore, the short-circuit due to dew condensation water or the like does not occur between the battery can and the battery can of the adjacent battery, or between the battery can and the housing of the battery pack. Further, it is inexpensive because one sheet of insulating film can provide the above effects.

### BRIEF DESCRIPTION OF DRAWINGS

FIG. 1 is an outside perspective view of a rectangular secondary battery in Example 1.

FIG. 2 is an exploded perspective view of the rectangular secondary battery illustrated in FIG. 1.

FIG. 3 is an exploded perspective view of a wound electrode group.

FIG. 4 is a development view of an insulating film in Example 1.

FIG. 5 is a bonding state diagram of the insulating film in Example 1.

FIG. 6 is a development view of an insulating film in Example 2.

FIG. 7 is a bonding state diagram of the insulating film in Example 2.

FIG. 8 is a development view of an insulating film in Example 3.

FIG. 9 is a bonding state diagram of the insulating film in Example 3.

FIGS. 10(a) and 10(b) FIG. 10(a) is a development view of an insulating film, and FIG. 10(b) is an outside perspective view of a rectangular secondary battery in Example 4.

FIG. 11 is an outside perspective view of a rectangular secondary battery in Example 5.

FIG. 12 is an outside perspective view of a rectangular secondary battery in Example 6.

### DESCRIPTION OF EMBODIMENTS

Examples of the present invention are described below along with the accompanying drawings.

### Example 1

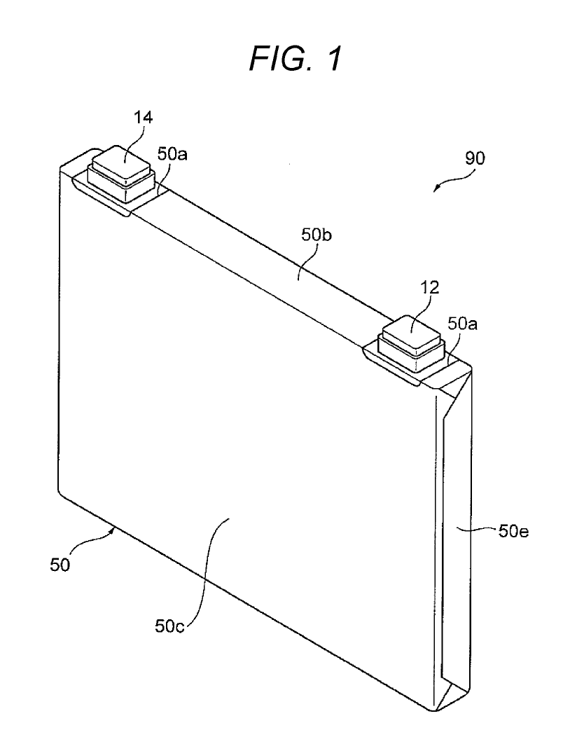

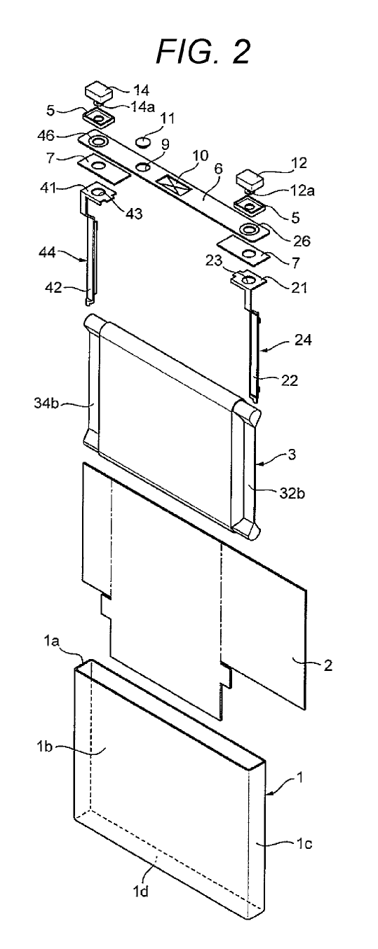

FIG. 1 is an outside perspective view of a rectangular secondary battery in Example 1, and FIG. 2 is an exploded perspective view of the rectangular secondary battery.

The rectangular secondary battery 90 is provided with a battery container including a battery can 1 and a battery lid 6 that are made of metal, and an outside of the battery container is covered with an insulating film 50. The battery can 1 has a side surface including a pair of opposed wide-side surfaces 1b having a relatively large area and a pair of opposed narrow-side surfaces 1c having a relatively small area, a bottom surface 1d, and an opening part 1a thereabove. In other words, the battery can 1 has the rectangular bottom surface 1d, the pair of wide-side surfaces 1b rising from a pair of long sides of the bottom surface 1d, and a pair of narrow-side surfaces 1c rising from a pair of short sides of the bottom surface 1d. The battery lid 6 is of a size to block an opening part 1a, and provided with a positive electrode external terminal 14 and a negative electrode external terminal 12.

The battery can 1 houses a wound group 3 therein, and the opening part 1a of the battery can 1 is sealed with the battery lid 6. The battery lid 6 has a substantially rectangular flat plate shape, and is welded so as to close the upper opening part 1a of the battery can 1 to seal the battery can 1. The battery lid 6 is provided with the positive electrode external terminal 14 and the negative electrode external terminal 12. Via the positive electrode external terminal 14 and the negative electrode external terminal 12, the wound group 3 is charged, and electric power is supplied to an external load. The battery lid 6 is integrally provided with a gas discharge valve 10. When a pressure increases in the battery container, the gas discharge valve 10 opens, and gas is discharged from inside to reduce the pressure in the battery container.

One sheet of insulating film 50 is bonded to the outer surface of the battery container that is formed by the battery can 1 sealed with the battery lid 6. The insulating film 50 has opening parts for exposing the external terminals of the battery, and covers the outer surface of the battery container excluding the periphery of the external terminals such that all six faces are watertight.

The battery can 1 of the rectangular secondary battery 90 houses the wound group 3 therein via an insulation protection film 2. Since the wound group 3 is wound in a flat shape, the wound group 3 has a pair of curved portions in a cross-sectional semi-circular shape that are opposed to each other, and a flat portion formed continuously between the pair of curved portions. The wound group 3 is inserted from one side of the curved portions into the battery can 1 such that a winding axis direction is along a lateral width direction of the battery can 1, and the other side of the curved portions is arranged on the upper opening side.

A positive electrode metal-foil-exposed part 34b of the wound group 3 is electrically connected to a positive electrode external terminal 14 that is provided on the battery lid 6, via a positive electrode collector plate (collector terminal) 44. Further, a negative electrode metal-foil-exposed part 32b of the wound group 3 is electrically connected to a negative electrode external terminal 12 that is provided on the battery lid 6, via a negative electrode collector plate (collector terminal) 24. Consequently, electric power is supplied from the wound group 3 to the external load via the positive electrode collector plate 44 and the negative electrode collector plate 24, and externally generated power is supplied and charged to the wound group 3 via the positive electrode collector plate 44 and the negative electrode collector plate 24.

Gaskets 5 and insulating plates 7 are provided on the battery lid 6 to electrically insulate the positive electrode collector plate 44 and negative electrode collector plate 24, and the positive electrode external terminal 14 and the negative electrode external terminal 12, respectively from the battery lid 6. Further, after an electrolyte solution is injected from a liquid injection port 9 into the battery can 1, a liquid injection plug 11 is joined to the battery lid 6 by laser welding to seal the liquid injection port 9 and hermetically close the rectangular secondary battery 90.

In this case, a material for forming the positive electrode external terminal 14 and the positive electrode collector plate 44 includes, for example, an aluminum alloy, and a material for forming the negative electrode external terminal 12 and the negative electrode collector plate 24 includes, for example, an a copper alloy. In addition, a material for forming the insulating plates 7 and the gaskets 5 includes, for example, a resin material having an insulating property such as a polybutylene terephthalate, a polyphenylene sulfide, a perfluoroalkoxy fluororesin.

Further, on the battery lid 6, a liquid injection port 9 is bored for injecting the electrolyte solution into the battery container, and after the electrolyte solution is injected into the battery container, the liquid injection port 9 is sealed with the liquid injection plug 11. In this case, as the electrolyte solution to be injected into the battery container includes, for example, a nonaqueous electrolyte solution may be applied, in which a lithium salt such as a lithium hexafluorophosphate (LiPF₆) is dissolved in a carbonic-acid ester-based organic solvent including an ethylene carbonate.

The positive electrode external terminal 14 and the negative electrode external terminal 12 have a weld joint part to be joined by welding to a bus bar or the like. The weld joint part has a rectangular parallelepiped block shape protruding upward from the battery lid 6, and is configured such that a lower surface faces the surface of the battery lid 6, and an upper surface is in parallel with the battery lid 6 at a predetermined height position.

A positive electrode connection part 14a and a negative electrode connection part 12a protrude respectively from lower surfaces of the positive electrode external terminal 14 and the negative electrode external terminal 12, and have tips in a cylindrical shape that can be inserted into a positive electrode side through-hole 46 and a negative electrode side through-hole 26 of the battery lid 6. The positive electrode connection part 14a and the negative electrode connection part 12a protrude through the battery lid 6 toward inside the battery can 1 more than the positive electrode collector plate base part 41 and the negative electrode collector plate base part 21, of the positive electrode collector plate 44 and the negative electrode collector plate 24. The tips are caulked to integrally fix the positive electrode external terminal 14, negative electrode external terminal 12, the positive electrode collector plate 44, and negative electrode collector plate 24 to the battery lid 6. The gaskets 5 are interposed between the positive electrode external terminal 14 and the battery lid 6, and between the negative electrode external terminal 12 and the battery lid 6, while the insulating plates 7 are interposed between the positive electrode collector plate 44 and the battery lid 6, and between the negative electrode collector plate 24 and the battery lid 6.

The positive electrode collector plate 44 and the negative electrode collector plate 24 have a positive electrode collector plate base part 41 and a negative electrode collector plate base part 21 that are in a rectangular plate shape and are arranged facing the lower surface of the battery lid 6. The positive electrode collector plate 44 and the negative electrode collector plate 24 also have a positive-electrode-side connection end 42 and a negative-electrode-side connection end 22 that are folded at side ends of the positive electrode collector plate base part 41 and the negative electrode collector plate base part 21, that extend toward the bottom surface 1d side along the wide-width surfaces of the battery can 1, and that are connected to the positive-electrode metal-foil exposed part 34b and the negative electrode metal-foil-exposed part 32b of the wound group 3 so as to face and overlap with a positive electrode metal-foil-exposed part 34b and a negative-electrode metal-foil exposed part 32b. The positive electrode collector plate base part 41 and the negative electrode collector plate base part 21 are respectively formed with a positive electrode side opening hole 43 and a negative electrode side opening hole 23 through which the positive electrode connection part 14a and the negative electrode connection part 12a are inserted.

The insulation protection film 2 is wound around the wound group 3 in a direction along a flat surface of the wound group 3, and around an orthogonal direction to winding axis direction of the wound group 3 as a central axis direction. The insulation protection film 2 is formed by one sheet made of a synthetic resin, for example, a PP (polypropylene) or the like, or by a plurality of film members. The insulation protection film 2 can be wound in a direction parallel to the flat surface of the wound group 3, and around the orthogonal direction to winding axis direction of the wound group 3 as a winding center, to insulate between the wound group 3 and the battery can 1.

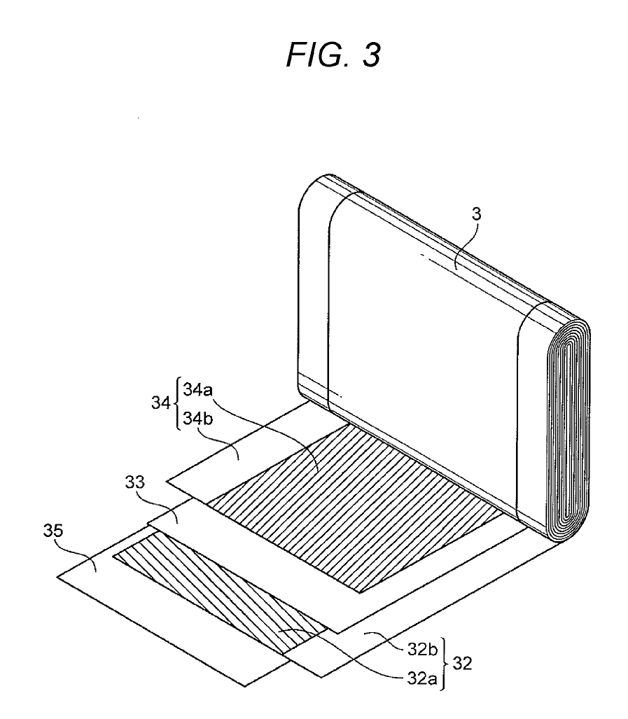

FIG. 3 is an exploded perspective view illustrating a state in which a part of a wound electrode group is developed. The wound group 3 is configured by flatly winding a negative electrode 32 and a positive electrode 34 via separators 33 and 35 therebetween. While the outermost peripheral electrode of the wound group 3 is the negative electrode 32, the separators 33 and 35 are wound further outside thereof. The separators 33 and 35 have a role to insulate between the positive electrode 34 and the negative electrode 32.

A portion on which a negative electrode mixture layer 32a is applied of the negative electrode 32 is larger in a width direction than a portion on which a positive electrode mixture layer 34a is applied of the positive electrode 34. Consequently, a configuration is such that the portion on which the positive electrode mixture layer 34a is applied is always interposed by the portion on which the negative electrode mixture layer 32a is applied. The positive electrode metal-foil-exposed part 34b and the negative electrode metal-foil-exposed part 32b are bundled at a flat part and connected by welding or the like. It should be noted that although the separators 33 and 35 are wider in a width direction than the portion on which the negative electrode mixture layer 32a is applied, it does not interfere when the positive electrode metal-foil-exposed part 34b and the negative electrode metal-foil-exposed part 32b are bundled and welded because the separators 33 and 35 are wound in a position where metal foil surfaces at ends are exposed on the positive electrode metal-foil-exposed part 34b and the negative electrode metal-foil-exposed part 32b.

The positive electrode 34 has the positive electrode mixture layer on both sides of the positive electrode metal foil serving as a positive electrode collector, and the positive electrode metal-foil-exposed part 34b on which a positive electrode mixture is not applied is provided at one side end in a width direction of the positive electrode metal foil.

The negative electrode 32 has the negative electrode mixture layer on both sides of the negative electrode metal foil serving as a negative electrode collector, and the negative electrode metal-foil-exposed part 32b on which a negative electrode mixture is not applied is provided at the other side end in a width direction of the negative electrode foil. The positive electrode metal-foil-exposed part 34b and the negative electrode metal-foil-exposed part 32b are areas where metal surfaces of the metal foils are exposed, and are wound so as to be arranged at positions on one side and the other side in a winding axis direction.

For the negative electrode 32, a negative electrode mixture was prepared by adding 10 parts by weight of polyvinylidene fluoride (hereinafter referred to as PVDF) as a binder based on 100 parts by weight of amorphous carbon powder as a negative electrode active material, and adding to the above and kneading N-methylpyrrolidone (hereinafter referred to as NMP) as dispersing solvent. This negative electrode mixture was applied on both sides of a copper foil (negative metal foil) having a thickness of 10 μm with a weld part (negative electrode uncoated part) left. After that, steps of drying, pressing and cutting are carried out to obtain the negative electrode 32 that has a thickness of 70 μm of a negative electrode active material coated-part excluding the copper foil.

It should be noted that although an example that uses an amorphous carbon as the negative electrode active material has been illustrated in this embodiment, it is not limited thereto, and the material may be natural graphite which lithium ions can be inserted into and removed from, a variety of artificial graphite materials, carbon materials such as cokes, compounds such as Si or Sn (e.g. SiO, TiSi₂ or the like), or a composite material thereof. The particle shape may be scale-like, spherical, fibrous, lump-like, or the like, and is also not particularly limited.

For the positive electrode 34, a positive electrode mixture was prepared by adding 10 parts by weight of scale-like graphite as a conducting material and 10 parts by weight of PVDF as a binder based on 100 parts by weight of lithium manganate (chemical formula LiMn₂O₄) as a positive electrode active material, and adding to the above and kneading NMP as a dispersing solvent. This positive electrode mixture was applied on both sides of an aluminum foil (positive electrode foil) having a thickness of 20 μm with a weld part (positive electrode uncoated part) left. After that, steps of drying, pressing and cutting are carried out to obtain the positive electrode 34 that has a thickness of 90 μm of a positive electrode active material coated-part excluding the aluminum foil.

Although an example that uses lithium manganate as the positive electrode active material has been illustrated in this embodiment, it is possible to use other lithium manganate having a spinel crystal structure, lithium manganese complex oxide in which lithium manganese oxide is partially substituted or doped with a metal element, lithium cobaltate or lithium titanate having a lamellar crystal structure, or lithium-metal complex oxide in which the above lithium cobaltate or lithium titanate is partially substituted or doped with a metal element.

Additionally, although an example that uses PVDF as the binder of a coated part in the positive electrode and the negative electrode has been illustrated in this embodiment, it is possible to use a polymer such as polytetrafluoroethylene (PTFE), polyethylene, polystyrene, polybutadiene, butyl rubber, nitrile rubber, styrene-butadiene rubber, polysulfide rubber, nitrocellulose, cyanoethyl cellulose, a variety of latexes, acrylonitrile, vinyl fluoride, vinylidene fluoride, propylene fluoride, chloroprene fluoride, or an acrylic-based resin, a mixture of the above, and the like.

Further, it is possible to use a shaft core, for example, configured by winding a resin sheet that has a higher bending rigidity than any of the positive electrode metal foil, the negative electrode metal foil, and separators 33 and 35.

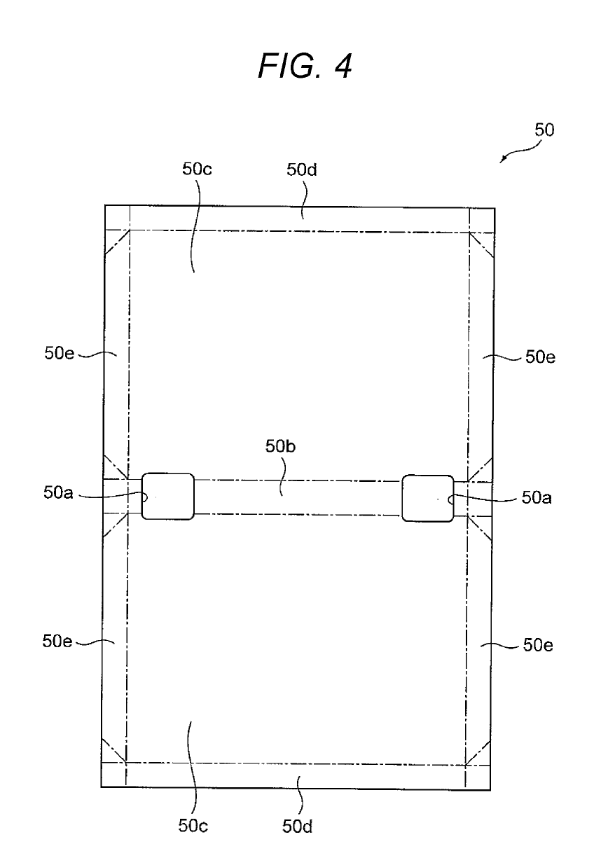

FIG. 4 is a development view of an insulating film in Example 1. The insulating film 50 is formed of one sheet of film, and has a rectangular outer shape. The lines shown by dotted lines indicate folding lines at the time when the insulating film 50 is bonded to the battery container. The insulating film 50 may be divided into a battery lid opposing part 50b corresponding to the battery lid 6 which is the upper surface of the battery container, wide-side-surface opposing parts 50c corresponding to the wide-side surfaces 1b, a bottom surface opposing parts 50d corresponding to the bottom surface 1d of the battery container, a narrow-side-surface opposing parts 50e corresponding to the narrow-side surfaces 1c, and the like. The insulating film 50 is provided with opening parts 50a for respectively exposing the positive electrode external terminal 14 and the negative electrode external terminal 12 of the rectangular secondary battery 90.

The insulating film 50 is provided with a pair of wide-side-surface opposing parts 50c and 50c via the battery lid opposing part 50b therebetween, and with bottom surface opposing parts 50d and 50d at ends on the sides where the pair of wide-side-surface opposing parts 50c and 50c are separated from each other. The bottom surface opposing parts 50d and 50d are of a size to be at least partially overlapped with each other on the bottom surface 1d to completely cover the bottom surface 1d. Additionally, the narrow-side-surface opposing parts 50e and 50e similarly are of a size to be at least partially overlapped on the narrow-side surfaces 1c to completely cover the narrow-side surfaces 1c.

A material used for the insulating film 50 includes, for example, polypropylene, polyethylene, polyethylene terephthalate, polycarbonate, polybutylene terephthalate, polyvinyl chloride, polyvinylidene chloride, polystyrene, polyacrylonitrile. The insulating film 50 has an adhesive layer on a surface facing the battery container to be bonded to the battery container.

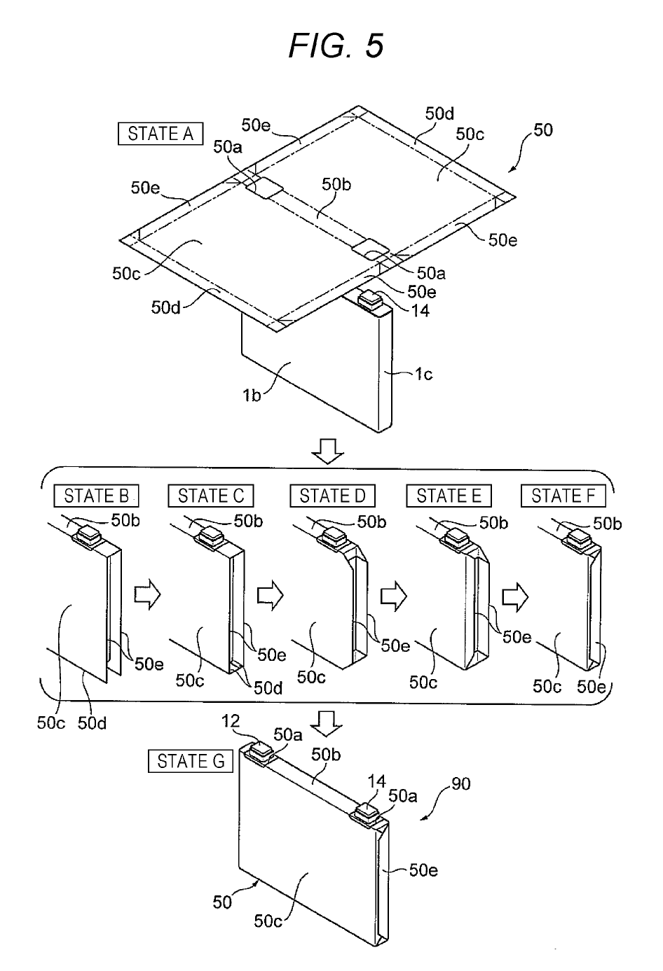

FIG. 5 is a bonding state diagram of the insulating film in Example 1. The insulating film 50 is bonded to the rectangular secondary battery 90 from the upper surface side thereof (STATE A). First, the battery lid opposing part 50b of the insulating film 50 is bonded to the battery lid 6. At this time, external terminals 12 and 14 are in a state being exposed from the opening parts 50a. Next, the wide-side-surface opposing parts 50c are bonded to the wide-side surfaces 1b of the battery container (STATE B). Here, the wide-side-surface opposing parts 50c and 50c are respectively bonded to a pair of wide-side surfaces 1b and 1b.

Next, the bottom surface opposing parts 50d and 50d are overlapped with each other and bonded on the bottom surface 1d of the battery container (STATE C). Next, portions protruding from the battery container, of the battery lid opposing part 50b, are folded in and bonded to the narrow-side surfaces 1c of the battery container, and portions protruding from the battery container, of the bottom surface opposing parts 50d, are folded in and bonded to the narrow-side surfaces 1c of the battery container (STATE D). Then, portions protruding from the battery container (narrow-side-surface opposing parts 50e), of the wide-side-surface opposing parts 50c, are overlapped with each other and bonded on the narrow-side surfaces 1c and 1c (STATE E and STATE F). Thus, the outer surface of the battery container is completely covered with the insulating film 50 (STATE G).

Consequently, the bottom surface opposing parts 50d are overlapped with each other on the bottom surface 1d of the battery container, and the pair of the narrow-side-surface opposing parts 50e are respectively overlapped with each other on the pair of the narrow-side surfaces 1c and 1c of the battery container, so that the insulating film 50 is overlapped with each other on three faces of the battery container.

According to the embodiment, one sheet of insulating film 50 covers the six faces of the battery container, ends of the insulating film 50 are overlapped with each other, and the insulating film 50 continuously covers mutually adjacent faces having each of ridges therebetween of the battery container.

The ridges of the battery container are covered with the insulating film 50 that continuously covers the faces adjacent to the ridges, except the portions corresponding to the opening parts 50a of the insulating film 50. Then, a continuous portion of the insulating film 50 covers eight corner portions where three ridges of the battery container cross, and adjacent faces having each of the three ridges therebetween.

Therefore, the outer surface of the battery container excluding the periphery of the external terminals 12 and 14 has an insulating property and watertightness. Thus, in a battery pack in which a plurality of rectangular secondary batteries 90 are combined in series or parallel, a short-circuit due to dew condensation water or the like does not occur between a battery container excluding the periphery of the external terminals 12 and 14 and a battery container of another adjacent battery, or between the battery container and a housing of the battery pack.

Additionally, it is inexpensive because one sheet of rectangular insulating film 50 can provide the above effects. Further, the opening parts 50a of the insulating film 50 are provided in a portion to which the insulating film 50 is bonded at first, so that the opening parts 50a is easily positioned with the external terminals 12 and 14 of the rectangular secondary battery 90 to make the bonding easier.

The order of bonding of the insulating film 50 to each parts of the battery container may be changed if the watertightness is maintained. Additionally, to improve the watertightness, the overlapped portions of the insulating film 50 may be joined by heat-welding or the like after bonding the insulating film 50.

### Example 2

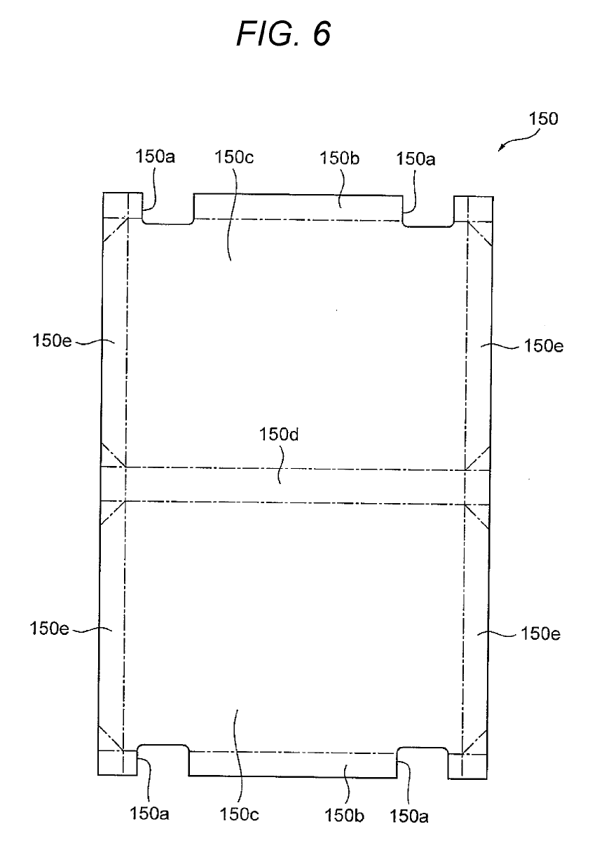

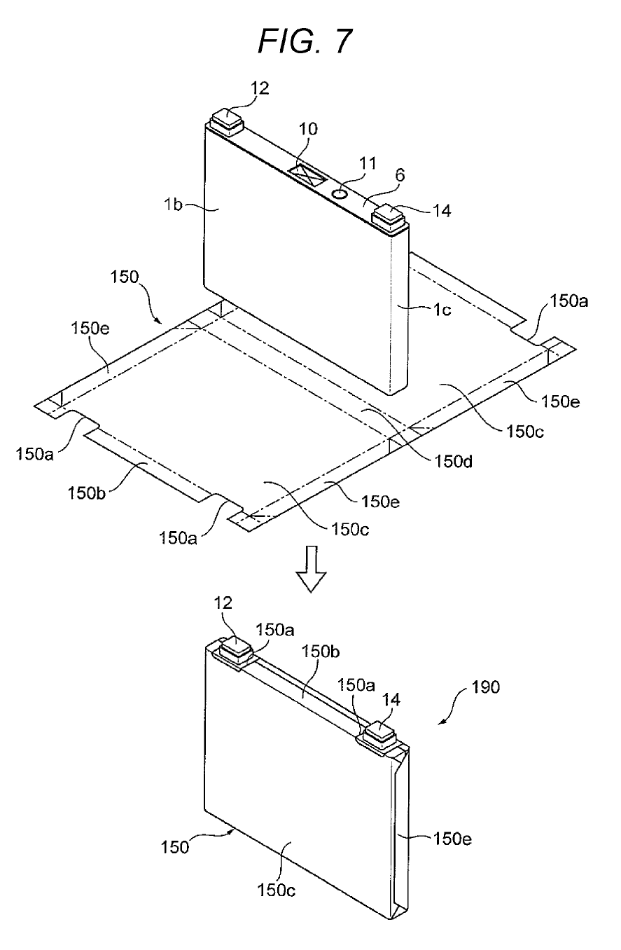

FIG. 6 is a development view of an insulating film in Example 2, and FIG. 7 is a bonding state diagram of the insulating film in Example 2. In this example, it is characteristic that an insulating film is structured to be bonded from a bottom surface 1d side of a battery container. It should be noted that the same signs are assigned to the same components as the example described above to omit the detailed description.

In a rectangular secondary battery 190, an outer surface of a battery container is covered with an insulating film 150. The insulating film 150 is formed of one sheet of film, and has a nearly rectangular outer shape. The lines shown by dotted lines indicate folding lines at the time when the insulating film 150 is bonded to the battery container. The insulating film 150 may be divided into a battery lid opposing part 150b facing a battery lid 6 which is an upper surface of the battery container, wide-side-surface opposing parts 150c facing wide-side surfaces 1b of the battery container, a bottom surface opposing part 150d corresponding to the bottom surface 1d of the battery container, narrow-side-surface opposing parts 150e corresponding to narrow-side surfaces 1c of the battery container, and the like. The battery lid opposing parts 150b of the insulating film 150 are formed with opening parts 150a for exposing external terminals 12 and 14.

The insulating film 150 is provided with a pair of the wide-side-surface opposing parts 150c and 150c via the bottom surface opposing part 150d therebetween, and with the battery lid opposing part 150b and 150b at ends on the sides where the pair of wide-side-surface opposing parts 150c and 150c are separated from each other. The battery lid opposing part 150b and 150b are of a size to be at least partially overlapped with each other on the battery lid 6 to completely cover the battery lid 6. Additionally, the narrow-side-surface opposing parts 150e and 150e similarly are of a size to be at least partially overlapped with each other on the narrow-side surfaces 1c to completely cover the narrow-side surfaces 1c.

A material used for the insulating film 150 includes, for example, polypropylene, polyethylene, polyethylene terephthalate, polycarbonate, polybutylene terephthalate, polyvinyl chloride, polyvinylidene chloride, polystyrene, polyacrylonitrile. The insulating film 150 has an adhesive layer on a surface facing the battery container to be bonded to the battery container.

The insulating film 150 is bonded from the bottom surface 1d side of the battery container in the order of the wide-side surfaces 1b and 1b, and the battery lid 6. First, the bottom surface opposing part 150d of the insulating film 150 is bonded to the bottom surface 1d of the battery container. Next, the wide-side-surface opposing parts 150c and 150c are bonded to the wide-side surfaces 1b and 1b. Next, the battery lid opposing part 150b and 150b are overlapped with each other and bonded on the battery lid 6. At this time, external terminals 12 and 14 are in a state being exposed from the opening parts 150a.

Next, portions respectively protruding from the battery container, in the battery lid opposing part 150b, the bottom surface opposing part 150d, and the wide-side-surface opposing parts 150c, are folded in and bonded to one side of the narrow-side surfaces 1c and the other side of the narrow-side surfaces 1c. First, portions respectively protruding from the battery container, of the battery lid opposing part 150b and the bottom surface opposing part 150d, are folded in and bonded to the one side of the narrow-side surfaces 1c. Next, portions protruding from the battery container (narrow-side-surface opposing parts 150e), of the wide-side-surface opposing parts 150c, are folded in and bonded on the one side of the narrow-side surfaces so as to be overlapped with each other. Then, the other side of the narrow-side surfaces are similarly folded in and bonded to the other side of the narrow-side surfaces 1c. Thus, the whole outer surface of the battery container is covered with the insulating film 150.

Consequently, the battery lid opposing parts 150b and 150b are overlapped with each other on the battery lid 6 of the battery container, and the pair of the narrow-side-surface opposing parts 150e and 150e are respectively overlapped with each other on the pair of the narrow-side surfaces 1c and 1c of the battery container, so that the parts of the insulating film 150 are overlapped with each other on three faces of the battery container.

According to the embodiment, one sheet of insulating film 150 covers the six faces of the battery container, ends of the insulating film 150 are overlapped with each other, and the insulating film 150 continuously covers mutually adjacent faces having each of ridges therebetween of the battery container.

The ridges of the battery container are covered with the insulating film 150 that continuously covers the faces adjacent to the ridges, except the portions corresponding to the opening parts 150a of the insulating film 150. Then, a continuous portion of the insulating film 150 covers eight corner portions where three ridges of the battery container cross and faces adjacent to the three ridges.

Therefore, the outer surface of the battery container excluding the periphery of the external terminals has an insulating property and watertightness. Thus, in a battery pack in which a plurality of secondary batteries are combined in series or parallel, a short-circuit due to dew condensation water or the like does not occur between a battery container excluding the periphery of the external terminals and a battery container of another adjacent battery, or between the battery container and a housing of the battery pack.

Additionally, it is inexpensive because one sheet of nearly rectangular insulating film 150 can provide the above effects. Furthermore, the insulating film 150 that covers the bottom surface 1d of the battery container has a thickness of one film, which improves a heat dissipation efficiency when the rectangular secondary battery 190 is to be cooled by bottom surface cooling.

The order of bonding of the insulating film 150 to each parts of the battery container may be changed if the watertightness is maintained. Additionally, to improve the watertightness, the overlapped portions of the insulating film 150 may be joined by heat-welding or the like after bonding the insulating film 150.

### Example 3

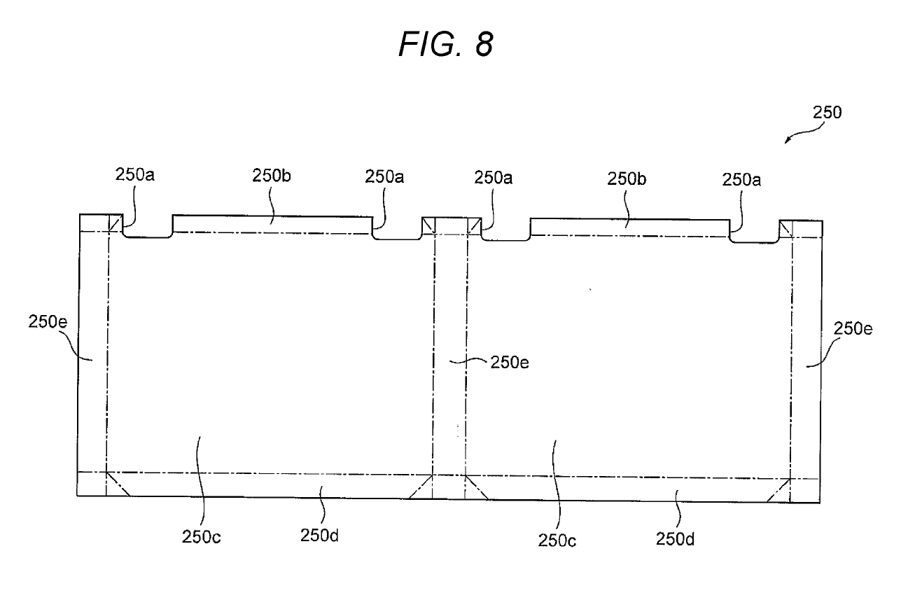

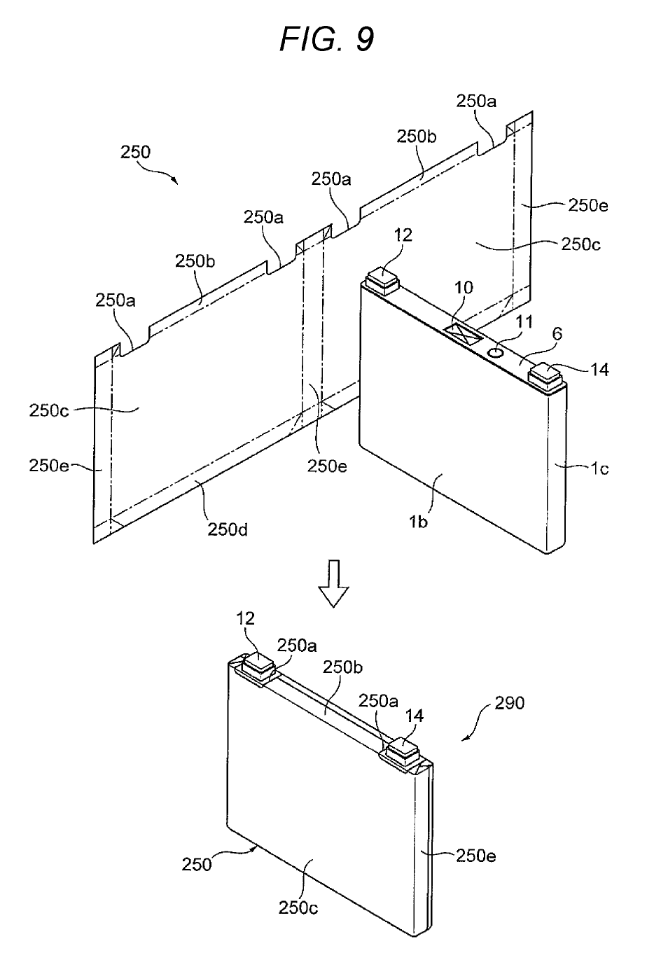

FIG. 8 is a development view of an insulating film in Example 3, and FIG. 9 is a bonding state diagram of the insulating film in Example 3. In this example, it is characteristic that an insulating film is structured to be bonded from a narrow-side surfaces side of a battery container. It should be noted that the same signs are assigned to the same components as the example described above to omit the detailed description.

In a rectangular secondary battery 290, an insulating film 250 in which an outer surface of the battery container is covered with the insulating film 250 is formed of one sheet of film, and has a nearly rectangular outer shape. The lines shown by dotted lines indicate folding lines at the time when the insulating film 250 is bonded to the battery container. The insulating film 250 may be divided into a battery lid opposing part 250b facing a battery lid 6, wide-side-surface opposing parts 250c facing wide-side surfaces 1b, a bottom surface opposing part 250d facing a bottom surface 1d, narrow-side-surface opposing parts 250e facing narrow-side surfaces, and the like. The battery lid opposing parts 250b of the insulating film 250 are provided with opening parts 250a for exposing external terminals 12 and 14.

The insulating film 250 is provided with a pair of the wide-side-surface opposing parts 250c and 250c via one side of the narrow-side-surface opposing parts 250e therebetween, and with the other side of the narrow-side-surface opposing parts 250e and 250e at ends on the sides where the pair of the wide-side-surface opposing parts 250c and 250c are separated from each other. The other side of narrow-side-surface opposing parts 250e and 250e are of a size to be at least partially overlapped with each other on the other side of narrow-side surfaces 1c to completely cover the other side of narrow-side surfaces 1c. The battery lid opposing part 250b and 250b are of a size to be at least partially overlapped with each other on the battery lid 6 to completely cover the battery lid 6. The bottom surface opposing parts 250d and 250d are of a size to be at least partially overlapped with each other on the bottom surface 1d to completely cover the bottom surface 1d.

A material used for the insulating film 250 includes, for example, polypropylene, polyethylene, polyethylene terephthalate, polycarbonate, polybutylene terephthalate, polyvinyl chloride, polyvinylidene chloride, polystyrene, polyacrylonitrile. The insulating film 250 has an adhesive layer on a surface of the insulating film 250 facing the battery container to be bonded to the battery container.

The insulating film 250 is bonded from one side of the narrow-side surfaces 1c of the battery container in the order of the wide-side surfaces 1b and the battery lid 6. First, the one side of the narrow-side-surface opposing parts 250e of the insulating film 250 are bonded to the one side of the narrow-side surfaces 1c of the battery container. Next, the wide-side-surface opposing parts 250c and 250c are bonded to the wide-side surfaces 1b and 1b. Next, the other side of the narrow-side-surface opposing parts 250e and 250e are overlapped with each other and bonded on a side of the narrow-side surfaces 1c that is opposite to the side which is firstly bonded. Next, portions respectively protruding from the battery container, in the battery lid opposing part 250b and the bottom surface opposing part 250d, are folded in and bonded to the battery lid 6 side and the bottom surface 1d side.

Consequently, the whole outer surface of the battery container is covered with the insulating film 250. The other side of the narrow-side-surface opposing parts 250e and 250e are overlapped with each other, the battery lid opposing part 250b and 250b are overlapped with each other on the battery lid 6 of the battery container, and the bottom surface opposing part 250d and 250d are overlapped with each other on the bottom surface 1d, so that the parts of the insulating film 250 are overlapped with each other on three faces of the battery container. Then, external terminals 12 and 14 of the battery are in a state being exposed from the opening parts 250a.

According to the embodiment, one sheet of insulating film 250 covers the six faces of the battery container, ends of the insulating film 250 are overlapped with each other, and the insulating film 250 continuously covers mutually adjacent faces having each of ridges therebetween of the battery container. The ridges of the battery container are covered with the insulating film 250 that continuously covers the faces adjacent to the ridges, except the portions corresponding to the opening parts 250a of the insulating film 250. Then, a continuous portion of the insulating film 250 covers eight corner portions where three ridges of the battery container cross and faces adjacent to the three ridges.

Therefore, the outer surface of the battery container excluding the periphery of the external terminals has an insulating property and watertightness. Thus, in a battery pack in which a plurality of secondary batteries are combined in series or parallel, a short-circuit due to dew condensation water or the like does not occur between a battery container excluding the periphery of the external terminals and a battery container of another adjacent battery, or between the battery container and a housing of the battery pack.

Additionally, it is inexpensive because one sheet of nearly rectangular insulating film 250 can provide the above effects. Furthermore, when the rectangular secondary battery 290 is integrated in an upper-level system (battery pack or the like), it can be accurately integrated by using the narrow-side surfaces as a positioning reference to achieve an approximately uniform thickness of the insulating film 250 in the narrow-side surfaces. However, when a plurality of the rectangular secondary batteries 290 are aligned in a line to be integrated such that the positive electrode and the negative electrode are alternately aligned, the insulating film 250 needs to be bonded such that the overlap of the narrow-side-surface opposing parts 250e is arranged on one side in a column-width direction.

The order of bonding of the insulating film 250 to each parts of the battery container may be changed if the watertightness is maintained. Additionally, to improve the watertightness, the overlapped portions of the insulating film 250 may be joined by heat-welding or the like after bonding the insulating film 250.

### Example 4

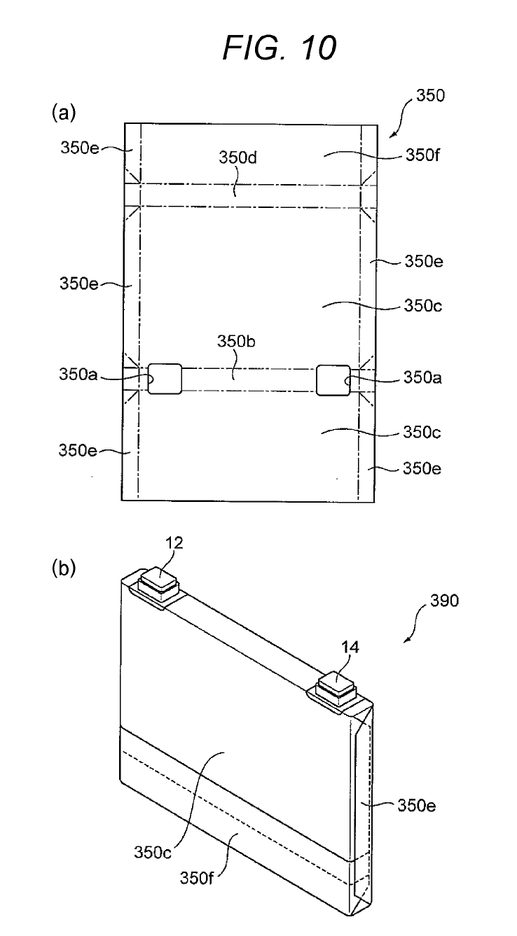

FIG. 10(a) is a development view of an insulating film, and FIG. 10(b) is an outside perspective view of a rectangular secondary battery in Example 4. In this example, it is characteristic that an insulating film is structured such that ends of the insulating film are overlapped on one side of the wide-side surfaces and a pair of the narrow-side surfaces. It should be noted that the same signs are assigned to the same components as the example described above to omit the detailed description.

In a rectangular secondary battery 390, an insulating film 350 in which an outer surface of the battery container is covered with the insulating film 350 is formed of one sheet of film, and has a rectangular outer shape. The lines shown by dotted lines indicate folding lines at the time when the insulating film 350 is bonded to the battery container. The insulating film 350 may be divided into a battery lid opposing part 350b facing a battery lid 6 which is an upper surface of the battery container, wide-side-surface opposing parts 350c and 350f facing wide-side surfaces 1b of the battery container, a bottom surface opposing part 350d facing the bottom surface 1d of the battery container, narrow-side-surface opposing parts 350e facing narrow-side surfaces of the battery container, and the like. The battery lid opposing part 350b of the insulating film 350 is formed with opening parts 350a for exposing external terminals 12 and 14.

The insulating film 350 is provided with a pair of wide-side-surface opposing parts 350c and 350c via the battery lid opposing part 350b therebetween, and with the bottom surface opposing part 350d at an end of a side which is separated from the battery lid opposing part 350b, of one side of the wide-side-surface opposing parts 350c. Then, the other side of the wide-side-surface opposing parts 350f is provided at an end on the side which is separated from the one side of the wide-side-surface opposing parts 350c via the bottom surface opposing part 350d therebetween. The other side of the wide-side-surface opposing parts 350c and 350f are of a size to be at least partially overlapped with each other on the other side of wide-side surfaces 1b to completely cover the wide-side surfaces 1b. Additionally, the narrow-side-surface opposing parts 350e and 350e similarly are of a size to be at least partially overlapped with each other on the narrow-side surfaces 1c to completely cover the narrow-side surfaces 1c.

A material used for the insulating film 350 includes, for example, polypropylene, polyethylene, polyethylene terephthalate, polycarbonate, polybutylene terephthalate, polyvinyl chloride, polyvinylidene chloride, polystyrene, polyacrylonitrile. The insulating film 350 has an adhesive layer on a surface facing the battery container to be bonded to the battery container.

The insulating film 350 is bonded from the battery lid 6 side of the battery container in the order of the wide-side surfaces 1b and 1b, and the bottom surface 1d. First, the battery lid opposing part 350b is bonded to the battery lid 6. At this time, external terminals 12 and 14 are in a state being exposed from the opening parts 350a. Next, the wide-side-surface opposing parts 350c and 350c are bonded to the wide-side surfaces 1b and 1b, and then the bottom surface opposing part 350d is bonded to the bottom surface 1d. Then, an end of the wide-side-surface opposing parts 350f is bonded so as to overlap with an end of the wide-side-surface opposing parts 350c on one side of the wide-side surfaces 1b.

Next, portions respectively protruding from the battery container, in the battery lid opposing part 350b, the bottom surface opposing part 350d, and the wide-side-surface opposing parts 350c, are folded in and bonded to one side of the narrow-side surfaces 1c and the other side of the narrow-side surfaces 1c.

First, the portions respectively protruding from the battery container, of the battery lid opposing part 350b and the bottom surface opposing part 350d, are folded in and bonded to the one side of the narrow-side surfaces 1c. Next, portions protruding from the battery container (narrow-side-surface opposing parts 350e and 350e), of the wide-side-surface opposing parts 350c, are folded in the one side of the narrow-side surfaces 1c and bonded on the one side of the narrow-side surfaces 1c so as to be overlapped with each other. Then, the other side of the narrow-side surfaces are similarly folded in and bonded on the other side of the narrow-side surfaces 1c so as to be overlapped with each other. Thus, the whole outer surface of the battery container is covered with the insulating film 350.

Consequently, the wide-side-surface opposing parts 350c and 350f are overlapped with each other on the one side of the wide-side surfaces 1b of the battery container, and the pair of the narrow-side-surface opposing parts 350e and 350e are respectively overlapped with each other on the pair of the narrow-side surfaces 1c and 1c of the battery container, so that the parts of the insulating film 350 are overlapped with each other on three faces of the battery container.

According to the embodiment, one sheet of insulating film 350 covers the six faces of the battery container, ends of the insulating film 350 are overlapped with each other, and the insulating film 350 continuously covers mutually adjacent faces having each of ridges therebetween of the battery container.

The ridges of the battery container are covered with the insulating film 350 that continuously covers the faces adjacent to the ridges, except the portions corresponding to the opening parts 350a of the insulating film 350. Then, a continuous portion of the insulating film 350 covers eight corner portions where three ridges cross of the battery container and faces adjacent to the three ridges.

Therefore, the outer surface of the battery container excluding the periphery of the external terminals has an insulating property and watertightness. Thus, in a battery pack in which a plurality of secondary batteries are combined in series or parallel, a short-circuit due to dew condensation water or the like does not occur between a battery container excluding the periphery of the external terminals and a battery container of another adjacent battery, or between the battery container and a housing of the battery pack.

Additionally, it is inexpensive because one sheet of rectangular insulating film 350 can provide the above effects. Further, the opening parts 350a are provided in a portion to which the insulating film 350 is bonded at first, so that the opening parts 350a is easily positioned with the external terminals 12 and 14 to make the bonding easier.

While the insulating film is overlapped on the bottom surface 1d of the battery container in Example 1, in this example, the insulating film 350 is not overlapped on the bottom surface 1d of the battery container, so that the insulating film 350 that covers the bottom surface 1d of the battery container has a thickness of one film. Therefore, a heat dissipation efficiency is improved when the rectangular secondary battery 390 is to be cooled by bottom surface cooling. Furthermore, since the upper surface and the bottom surface of the battery container are covered with one sheet of a film, the upper surface and the bottom surface can be used as a positioning reference, which enables an accurate integration when the rectangular secondary battery 390 is integrated in an upper-level system (battery pack or the like).

Although the insulating film 350 is obtained by partially modifying the insulating film 50 in Example 1, a similar one may be obtained by changing the insulating film 150 of Example 2. Additionally, a similar modification may be applied to the insulating film 250 of Example 3, and in this case, both sides of the narrow-side surfaces 1c and 1c of the rectangular secondary battery are to be covered with a thickness of one sheet of film. Therefore, both sides of the narrow-side surfaces can be used as a positioning reference, which enables an accurate integration when the rectangular secondary battery is integrated in an upper-level system (battery pack or the like).

The order of bonding of the insulating film 350 to each parts of the battery container may be changed if the watertightness is maintained. Additionally, to improve the watertightness, the overlapped portions of the insulating film 350 may be joined by heat-welding or the like after bonding the insulating film 350.

### Example 5

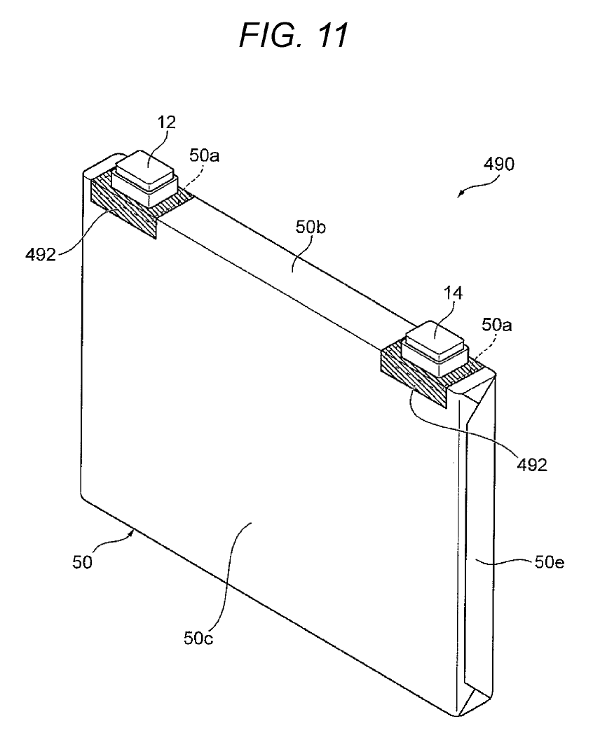

FIG. 11 is an outside perspective view of a rectangular secondary battery in Example 5. In this example, it is characteristic that a protective layer is provided for blocking an opening part of the insulating film. It should be noted that the same signs are assigned to the same components as the example described above to omit the detailed description.

A battery container is partially exposed at opening parts 50a of an insulating film 50. A rectangular secondary battery 490 in this example has a protective layer (protective film) 492 for covering the exposed portion of the outer surface of the battery container. The protective layer 492 has an insulating property, and is formed, for example, by coating. A material used is, for example, epoxy, acrylic, urethane, or rubber. The protective layer 492 may be provided partially overlapping with the insulating film 50. A process of forming the protective layer 492 on the battery container may be before or after bonding the insulating film.

The outer surface of the battery container is provided with an insulating property and a watertightness by the insulating film 50 and the insulating protective layer 492. In this example, the outer surface including a periphery of the external terminals of the rectangular secondary battery has the insulating property and the watertightness. Thus, in a battery pack in which a plurality of secondary batteries are combined in series or parallel, a short-circuit due to dew condensation water or the like does not occur between a battery container and a battery container of another adjacent battery, or between the battery container and a housing of the battery pack.

It should be noted that, although the insulating film 50 of Example 1 is used as an example of the insulating film in this example, any one of insulating films 150, 250, and 350 described in other Examples 2 to 4 may be used.

### Example 6

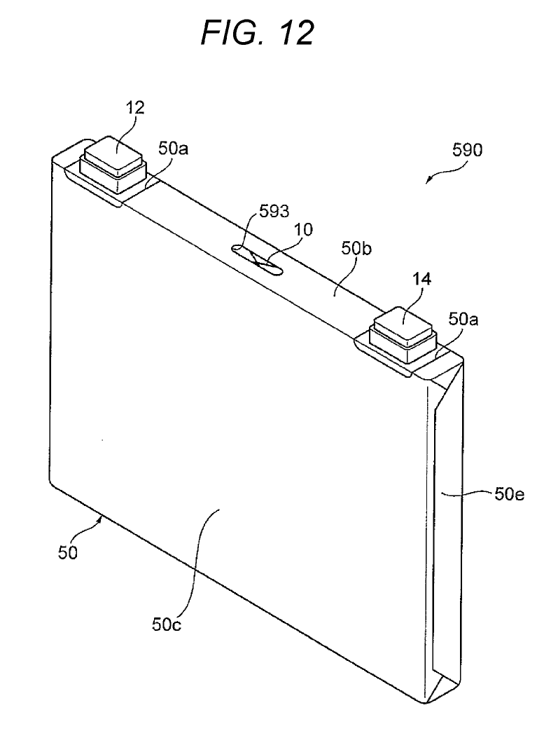

FIG. 12 is an outside perspective view of a rectangular secondary battery in Example 6. In this example, it is characteristic that an opening part is provided at a position facing a gas discharge valve, on the insulating film. It should be noted that the same signs are assigned to the same components as the example described above to omit the detailed description.

While the rectangular secondary batteries 90, 190, 290, and 390 of above Examples 1 to 4 have a configuration in which the entire outer surface of the battery container excluding the periphery of the external terminals is covered with an insulative film, the rectangular secondary battery 590 in this example has a configuration in which at least a part of the gas discharge valve is also exposed in addition to the periphery of the external terminals.

The insulating film 50 has opening parts 50a for externally exposing the external terminals 12 and 14 and an opening part 593 for exposing at least a part of the gas discharge valve 10, and covers the outer surface of the battery container excluding the periphery of the external terminals 12 and 14 and at least a part of the gas discharge valve 10 such that all six faces are watertight.

For example, when the rectangular secondary battery 590 is integrated in a battery pack or the like in which the gas discharge valve 10 is mounted with a duct for discharging gas, the gas discharge valve 10 is isolated by the duct for discharging gas so that the necessity for having an insulating property is low. In the rectangular secondary battery 590, the opening part 593 for discharging gas is provided on the insulating film 50 to expose at least apart of the gas discharge valve 10, so that gas discharging is carried out more easily when gas is discharged from the gas discharge valve 10 in an abnormal situation.

It should be noted that although an example has been described where the opening part 593 for discharging gas is provided on the insulating film 50 of Example 1 in this example, the opening part 593 may be provided on any one of insulating films 150, 250 and 350 described in other Examples 2 to 4.

Although embodiments of the present invention have been described in detail above, the invention is not limited to the above embodiments, and various modifications of design may be made without departing from the spirit of the invention described in claims. For example, the above embodiments have been illustrated in detail to facilitate description for easy understanding, and are not necessarily limited to the examples that include all the illustrated configurations. Moreover, a part of a configuration of an embodiment can be replaced with a configuration of another embodiment, and a configuration of an embodiment can also be added with a configuration of another embodiment. Moreover, part of a configuration of each embodiment may be deleted, replaced, added with another configuration.

### REFERENCE SIGNS LIST

1 battery can
3 wound group
6 battery lid
10 gas discharge valve
12 negative electrode external terminal
14 positive electrode external terminal
50, 150, 250, 350 insulating film
90, 190, 290, 390, 490, 590 rectangular secondary battery
492 protective layer
593 opening part for discharging gas

1. A rectangular secondary battery in which six faces of a battery container are covered with one sheet of insulating film, wherein
ends of the insulating film are overlapped with each other, and the insulating film continuously covers mutually adjacent faces having each of ridges therebetween of the battery container.

2. The rectangular secondary battery according to claim 1, wherein the insulating film covers eight corner portions where three ridges of the battery container cross, and continuously covers adjacent faces having each of the three ridges therebetween.

3. The rectangular secondary battery according to claim 1, wherein the insulating film has an adhesive layer on a surface facing the battery container.

4. The rectangular secondary battery according to claim 1, wherein a material of the insulating film includes any of polypropylene, polyethylene, polyethylene terephthalate, polycarbonate, polybutylene terephthalate, polyvinyl chloride, polyvinylidene chloride, polystyrene, polyacrylonitrile.

5. The rectangular secondary battery according to claim 1, wherein ends of the insulating film are heat-welded to each other.

6. The rectangular secondary battery according to claim 1, wherein
the battery container has a battery can and a battery lid, the battery can having a rectangular bottom surface, a pair of wide-side surfaces rising from a pair of long sides of the bottom surface, and a pair of narrow-side surfaces rising from a pair of short sides of the bottom surface, the battery lid blocking an opening part of the battery can and being provided with external terminals,
the insulating film has bottom surface opposing parts facing a bottom surface of the battery can, a pair of wide-side-surface opposing parts facing the pair of wide-side surfaces, a pair of narrow-side-surface opposing parts facing the narrow-side surfaces of the battery can, and a battery lid opposing part facing the battery lid and being provided with an opening part for exposing the external terminals, and the parts of the insulating film are respectively overlapped with each other on three faces of the battery container.

7. The rectangular secondary battery according to claim 6, wherein the bottom surface opposing parts of the insulating film are overlapped with each other on the bottom surface of the battery can, and the narrow-side-surface opposing parts of the insulating film are respectively overlapped with each other on the pair of the narrow-side surfaces of the battery can.

8. The rectangular secondary battery according to claim 6, wherein the battery lid opposing parts of the insulating film are overlapped with each other on the battery lid of the battery container, and the pair of the narrow-side-surface opposing parts of the insulating film are respectively overlapped with each other on the pair of the narrow-side surfaces of the battery container.

9. The rectangular secondary battery according to claim 6, wherein one side of the narrow-side-surface opposing parts of the insulating film are overlapped with each other on one side of the narrow-side surfaces of the battery can, the bottom surface opposing parts of the insulating film are overlapped with each other on the bottom surface of the battery can, and the battery lid opposing parts of the insulating film are overlapped with each other on the battery lid of the battery container.

10. The rectangular secondary battery according to claim 6, wherein the wide-side-surface opposing parts of the insulating film are overlapped with each other on one side of wide-side surfaces of the battery can, and the pair of the narrow-side-surface opposing parts of the insulating film are respectively overlapped with each other on the pair of narrow-side surfaces of the battery can.

11. The rectangular secondary battery according to any one of claim 6, wherein the rectangular secondary battery has an insulating protective film for covering an outer surface of the battery container exposed from the opening part of the insulating film.

12. The rectangular secondary battery according to any one of claim 6, wherein the battery lid is provided with a gas discharge valve, and the insulating film has an opening part for discharging gas at a portion corresponding to the gas discharge valve.
